(19) United States
(12) Patent Application Publication
(10) Pub. No.: US 2008/0019046 A1
(43) Pub. Date: Jan. 24, 2008

(54) Disk Cartridge

(76) Inventors: Tomio Yamamoto, Hyogo (JP); Akira Kurozuka, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/596,140

(22) PCT Filed: Nov. 26, 2004
(86) PCT No.: PCT/JP04/17610

§ 371 Date: Feb. 16, 2007

(30) Foreign Application Priority Data
Dec. 2, 2003 (JP) 2003-402585

(51) Int. Cl. G11B 23/03

(52) U.S. Cl. 360/133

(57) ABSTRACT

A disk cartridge according to the present invention includes a case body 10, a shutter 11 and an elastic member 7. The case body 10 has a head window 12, which reaches a side surface, and a shutter opening groove 24 with a holding recess 26 at the bottom. The shutter portion 11 is subjected to the elastic force applied by the elastic member 7 so as to close the head window 12, thus preventing a record/reproduce head from interfering with the case body 10 and reducing the width of the disk cartridge. Also, a gripping member, provided for a disk drive to prevent the disk cartridge from popping out due to the reactive force caused by the elastic member 7, neither disengages itself from the holding recess 26 easily nor interferes with the head.

### TECHNICAL FIELD

The present invention relates to a disk cartridge for housing a disklike information storage medium such as a magnetic disk or an optical disk.

### BACKGROUND ART

Recently, disklike information storage media (which will be simply referred to herein as “disks”) have been used widely to store computer data and other types of data thereon. Meanwhile, disk drives for recording and/or reproducing information from/on those disks by means of light or magnetism have been developed.

In the meantime, technologies for increasing the storage capacities of those disks have also been developed. Under the circumstances such as these, higher-capacity, smaller-sized disk drives, which could be built in various mobile devices including disk movie cameras, are now in high demand. If such disk drives are needed, then the sizes of their compatible disk cartridges should also be reduced.

In general, a recordable disk is often stored in a disk cartridge to prevent the disk from being soiled with dust or finger marks. Also, the higher the storage capacity of a disk is, the more susceptible to dust or finger marks the disk tends to be. That is why such a disk needs a highly dustproof disk cartridge.

A typical conventional technology known in this field is disclosed in Patent Document No. 1 and is adopted in Mini Discs (MDs). Specifically, a disk cartridge of that type includes a head window, which partially exposes the disk to allow a record/reproduce head to access it, and a shutter for closing the head window. The shutter is designed so as to slide in the direction in which the disk cartridge is inserted into a disk drive, and includes a locking member for locking the shutter closed.

This shutter has a U-cross section with a substantially rectangular bottom and holds the body of the disk cartridge between it. The cartridge body has an engaging groove extending in the inserting direction. And a stopper projection provided for the shutter gets engaged with the engaging groove, thereby sliding the shutter in the inserting direction without dropping the shutter from the body.

The locking member is located deeper in the inserting direction than the head window is. To unlock the locking member, an opener tab is fixed on an inner side surface of a cartridge holder of a disk drive. To load the disk cartridge into the disk drive, first, the disk cartridge is inserted into the holder, when the opener tab moves inside a groove on a side surface of the disk cartridge, thereby pushing and unlocking the locking member. After that, the opener tab gets engaged with the shutter to open the shutter while the disk cartridge is being inserted deeper. When the disk cartridge is fully inserted, the head window will be opened, too.

When the disk cartridge is removed from the disk drive, the opener tab cannot close the shutter by itself. For that reason, a leaf spring is arranged on the inner side surface of the cartridge holder and gets engaged with a hole on the side surface of the shutter. If the disk cartridge is ejected from the cartridge holder while the leaf spring is holding the shutter, the shutter will close the head window.

As can be seen, the shutter driving mechanism of the disk cartridge disclosed in Patent Document No. 1 has such a simple structure as to contribute particularly effectively to realizing small-sized disks among other things.

On the other hand, Patent Document No. 2 discloses a disk cartridge that has a structure for applying elastic force to a shutter in its closing direction and thereby preventing the shutter from opening accidentally due to the impact caused by drop, for example. The disk cartridge includes a spring for applying elastic force to the shutter in its closing direction and a holding recess to get engaged with a gripping member provided for a disk drive. When the disk cartridge is loaded or unloaded, the gripping member of the disk drive holds the disk cartridge by getting engaged with the holding recess of the disk cartridge, thereby preventing the disk cartridge from being ejected out of the disk drive unintentionally due to the reactive force of the spring.
Patent Document No. 1: Japanese Patent No. 3030894
Patent Document No. 2: Japanese Patent Application Laid-Open Publication No. 2000-173223

### DISCLOSURE OF INVENTION

### Problems to be Solved by the Invention

However, the conventional disk cartridges have the following drawbacks.

In the disk cartridge disclosed in Patent Document No. 1, the engaging groove for guiding the shutter needs to be located outside the head window. In other words, the head window cannot be expanded beyond the engaging groove on the side surface. That is why the size of the record/reproduce head should be regulated so as not to interfere with the engaging groove structure of the disk cartridge even when the record/reproduce head is accessing the outermost portion of the disk. Nevertheless, to avoid regulating the size of the record/reproduce head, the distance from the outer periphery of the disk to the engaging groove should be increased, which would cause another problem because the disk cartridge would have increased outer dimensions in that case.

On the other hand, in the disk cartridge disclosed in Patent Document No. 2, the holding recess is located on the bottom of the cartridge. That is why when the shutter is closed by the spring's force, the gripping member would easily disengage itself from the holding recess, thus possibly making it difficult to hold the disk cartridge firmly enough.

An object of the present invention is to provide a small-sized and highly dustproof disk cartridge by overcoming at least one of these problems of the prior art.

### Means for Solving the Problems

A disk cartridge according to the present invention includes a case body, a shutter and an elastic member. The case body houses a disklike information storage medium in a rotatable position and includes: first and second side surfaces that extend parallel to an inserting direction, in which the disk cartridge is inserted into a disk drive for recording and/or reproducing information, and are opposed to each other; a lower surface sandwiched between the first and second side surfaces; a head window, cut through a portion of the lower surface, for partially exposing the information storage medium; a shutter opening groove provided on the first side surface so as to extend in the inserting direction and to slide a shutter opener of the disk drive therein; and a holding recess provided at the bottom of the shutter opening groove. The shutter has an operating portion that protrudes into the shutter opening groove and opens or closes the head window by sliding parallel to the inserting direction. And the elastic member applies elastic force to the shutter so as to close the head window.

In one preferred embodiment, the head window has been cut open through the first side surface and the lower surface so as to reach the first side surface.

In this particular preferred embodiment, the head window has been cut open through the first side surface so as not to interfere with the shutter opening groove or the holding recess.

In a specific preferred embodiment, the head window includes a side window that has been cut open through the first side surface and that is located closer to the lower surface than the shutter opening groove is.

In another preferred embodiment, the case body includes an upper half and a lower half, and the holding recess is defined by a rib of the lower half so as to form an integral part of the lower half.

In still another preferred embodiment, the case body has a holding notch that has been cut through the first side surface and the lower surface and another holding notch that has been cut through the second side surface and the lower surface.

In yet another preferred embodiment, the case body includes an elastic member sliding groove, which extends parallel to the shutter opening groove to have the elastic member slide therein, and a recess located at one end of the elastic member sliding groove. The elastic member sliding groove and the recess are both provided on the first side surface. While the head window is closed with the shutter portion, the elastic member engages with the recess, thereby keeping the shutter portion locked and fixed.

In this particular preferred embodiment, the shutter includes a shield, which covers the head window, and an unlocking member including the operating portion. When the shutter opener contacts with the operating portion, the unlocking member disengages the elastic member from the recess and the shutter opener slides the shutter portion against the elastic force applied by the elastic member.

In yet another preferred embodiment, the case body includes a third side surface, which faces the disk drive when the disk cartridge is going to be inserted into the disk drive, and a fourth side surface opposed to the third side surface. The shutter opening groove reaches the third side surface so as to form an opening on the third side surface.

In yet another preferred embodiment, the disk cartridge further includes the disklike information storage medium with an information storage side. The information storage medium is housed in the case body such that the information storage side is partially seen through the head window when the shutter is opened.

In this particular preferred embodiment, the case body further includes an upper surface that is sandwiched between the first and second side surfaces and that is opposed to the lower surface. The holding recess is positioned at the bottom of the shutter opening groove so as to be located closer to the upper surface than the information storage side of the information storage medium is when the information storage medium has been loaded into the disk drive such that information is readily reproduced from, or recorded on, the medium.

In another preferred embodiment, the holding recess is positioned at the bottom of the shutter opening groove so as to be located in the upper part of a space between the upper and lower surfaces of the case body.

A disk drive according to the present invention includes: a chassis; a motor supported on the chassis and including a turntable; a head, supported on the chassis, for recording and/or reproducing information; and a holder having an insertion port for inserting the disk cartridge of one of claims 1 to 12 and a space for holding the disk cartridge. The holder is rotatably secured to the chassis so as to take either a first position, at which the disk cartridge is insertable and removable through the insertion port without interfering with the turntable, or a second position, at which the information storage medium in the disk cartridge held in the space is mounted on the turntable. The disk drive further includes: a slider, which is arranged so as to slide with respect to the holder and which applies elastic force to the disk so as to eject the disk cartridge out of the holder through the insertion port; and a gripping member, which is connected to the slider so as to get engaged with the holding recess of the disk cartridge. The gripping member is arranged on the holder so as not to interfere with the head when the holder is turned to take the second position with no disk cartridge held.

### Effect of the Invention

The disk cartridge of the present invention includes an elastic member that applies elastic force to the shutter in its closing direction. Thus, by keeping the head window closed except when the head window should be opened, the dustproofness can be increased. In addition, since the holding recess is positioned in the shutter opening groove, the gripping member, which is provided for the disk drive to minimize the reactive force of the elastic member, will not disengage itself from the holding recess easily. What is more, interference between the gripping member and the lens actuator of a record/reproduce head can be avoided, too. As a result, a small-sized and highly dustproof disk cartridge can be provided.

### BRIEF DESCRIPTION OF DRAWINGS

FIG. 1 is an exploded perspective view illustrating a preferred embodiment of a disk cartridge according to the present invention.

FIG. 2 is a perspective view illustrating how the disk cartridge shown in FIG. 1 looks when its shutter is closed.

FIG. 3 is a perspective view illustrating how the disk cartridge shown in FIG. 1 looks when its shutter is opened.

FIG. 4 is a perspective view illustrating the structure of a disk drive compatible with the disk cartridge shown in FIG. 1.

FIG. 5A is a plan view illustrating a state where the disk cartridge shown in FIG. 1 is going to be loaded into the disk drive shown in FIG. 4.

FIG. 5B is a plan view illustrating a state where the disk cartridge shown in FIG. 1 is going to be loaded into the disk drive shown in FIG. 4.

FIG. 5C is a plan view illustrating a state where the disk cartridge shown in FIG. 1 has been loaded into the disk drive shown in FIG. 4.

FIG. 5D is a plan view illustrating a state where the disk cartridge shown in FIG. 1 has been unloaded from the disk drive shown in FIG. 4.

FIG. 6 is a plan view illustrating the position of the lower half in a situation where the disk cartridge shown in FIG. 1 has been loaded into the disk drive.

FIG. 7 shows a cross section of the overall disk cartridge as viewed on the plane B-B shown in FIG. 6.

FIG. 8 shows a side view of the overall disk cartridge as viewed from the direction C shown in FIG. 6.

### DESCRIPTION OF REFERENCE NUMERALS

1 upper half
2 lower half
3 information storage medium
4 clamping plate
5 shield
6 stopper
7 elastic member
8 unlocking member
10 case body
11 shutter
21 bottom window
22 side window
23 side rib
24 shutter opening groove
25 holding notch
26 holding recess
90 shutter opener
100 head
101 lens actuator
102 objective lens
110 gripping member
111 gripping member at standby position

### BEST MODE FOR CARRYING OUT THE INVENTION

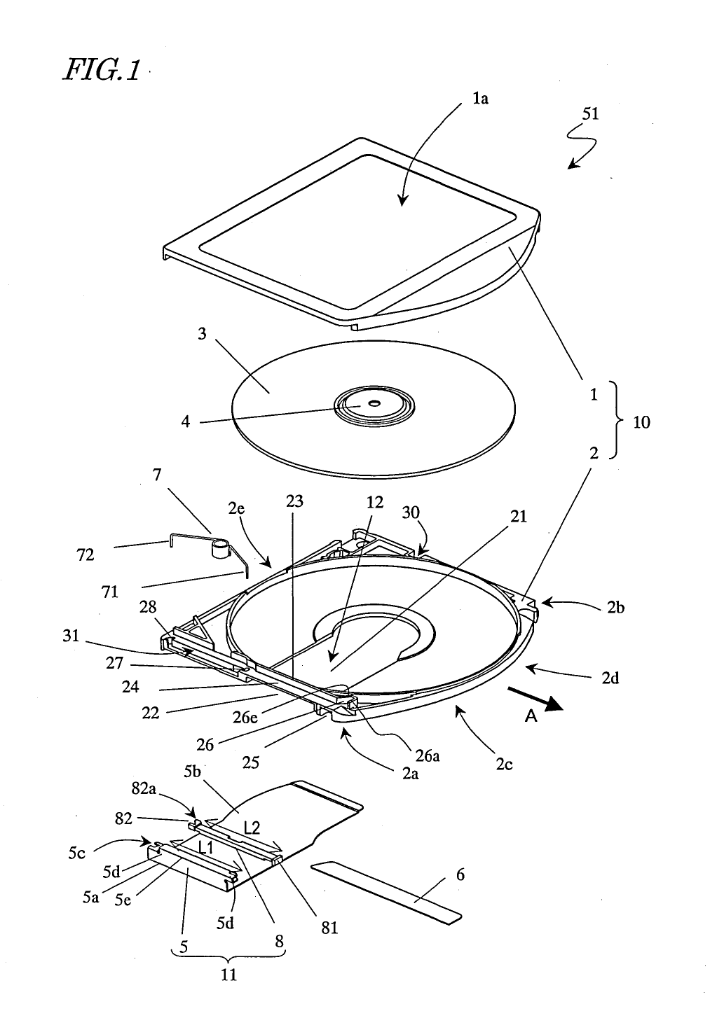

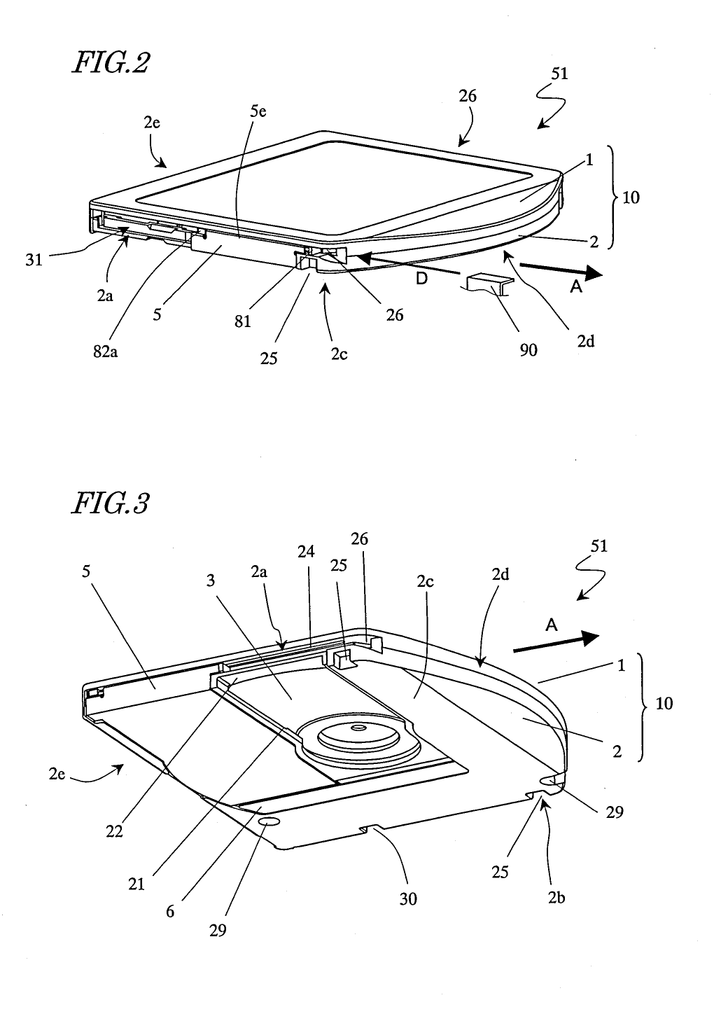

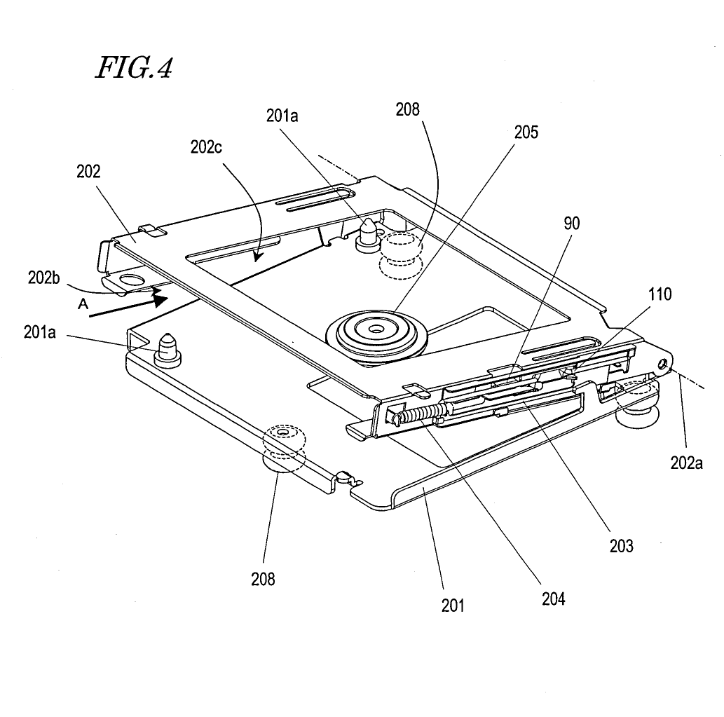

Hereinafter, preferred embodiments of a disk cartridge according to the present invention will be described. FIG. 1 is an exploded perspective view of a disk cartridge 51. FIGS. 2 and 3 are perspective views illustrating how the disk cartridge 51 looks when its shutter is closed and when its shutter is opened, respectively.

The disk cartridge 51 includes a disklike information storage medium 3, a case body 10, a shutter 11, and an elastic member 7.

The information storage medium 3 includes a storage layer, from/on which information can be reproduced or recorded by means of light or magnetism, for example. The storage layer may be either a write-once type or a rewritable type. Alternatively, the storage layer may even be a non-writable type on which data has already been stored. The size of the information storage medium 3 is not particularly limited, either. However, the present invention can be used particularly effectively to realize a disk cartridge that houses an information storage medium of a small diameter and that has small outer dimensions. The diameter of a preferred information storage medium 3 is about 80 mm or less.

The case body 10 includes an upper half 1 and a lower half 2 and houses the information storage medium 3 in a rotatable position. A clamping plate 4, which is arranged around the center hole of the information storage medium 3 and is attracted to a turntable via magnetism, may form an integral part of the case body 10 such that the medium 3 can be mounted on the turntable firmly. As shown in these drawings, the case body 10 includes a first side surface 2a and a second side surface 2b, which extend parallel to an inserting direction A in which the disk cartridge is inserted into a disk drive for recording and/or reproducing information and which are opposed to each other, and an upper surface 1a and a lower surface 2c sandwiched between the first and second side surfaces and opposed to each other. In this preferred embodiment, a third side surface 2d that faces the disk drive when this disk cartridge is going to be inserted into the disk drive is a gently curved raised surface, while a fourth side surface 2e, opposed to the third side surface 2d, is a flat surface. In this manner, by making only the third side surface 2d in a curved and raised shape, which is different from the others, the user can know the inserting direction of the disk cartridge 51 easily.

The case body 10 has a head window 12 for partially exposing the information storage medium 3 housed. Through this head window 12, a head for recording and/or reproducing information accesses the information storage medium 3. The head window 12 includes a bottom window 21 that has been cut through the lower surface 2c and preferably further includes a side window 22 that has been cut through the first side surface 2a. The bottom window 21 and the side window 22 are continuous with each other. In other words, the head window 12 covers not only the lower surface 2c but also the first side surface 2a. The first side surface 2a has a shutter opening groove 24 extending parallel to the inserting direction A. The shutter opening groove 24 reaches the third side surface 2d so as to form an opening on the third side surface 2d, too. A holding recess 26 is arranged at the bottom of the shutter opening groove 24 and near the third side surface 2d.

If the case body 10 consists of the upper and lower halves 1 and 2, any portion of the first and second side surfaces 2a and 2b may be defined by either of the upper and lower halves 1 and 2. In this preferred embodiment, the bottom of the shutter opening groove 24 on the first side surface 2a is defined by a side rib 23 of the lower half 2. Thus, the holding recess 26 arranged at the bottom of the shutter opening groove 24 also forms an integral part of the lower half 2 continuously with the side rib 23. By providing the holding recess 26, the rib 23 and the upper half 1 can be bonded together in an increased area. As a result, the bond strength between the upper and lower halves 1 and 2 can be increased.

Of the four side surfaces that form the holding recess 26, a side surface 26d that is perpendicular to the lower surface 2c and located close to the third side surface 2d is preferably perpendicular to the bottom of the shutter opening groove 24 such that the gripping member (to be described later) gets engaged with the holding recess 26 without fail. On the other hand, a side surface 26e that is perpendicular to the lower surface 2c and located close to the fourth side surface 2e may be sloped so as to define an obtuse angle with respect to the bottom of the shutter opening groove 24, for example. By providing such a sloped side surface 26e, the internal space of the cartridge body 10 can be expanded.

The lower surface 2c of the case body 10 has two positioning holes 29. One of the two positioning holes 29 is adjacent to the third side surface 2d of the case body 10 and the third side surface 2d has an opening, too. This positioning hole 29 is used to set the disk cartridge 51 at a predetermined position in the disk drive by getting fitted with a positioning pin provided for the disk drive. The third side surface 2d that should face the disk drive when the disk cartridge is inserted into the disk drive also has an opening that is continuous with the positioning hole 29. That is why into the positioning hole 29 adjacent to the third side surface 2d, can the positioning pin be inserted through the opening on the side surface 2d. Consequently, even when the disk drive adopts a structure that includes a holder rotating on a shaft provided at one end and that is designed to load the disk cartridge, inserted into the holder, into the disk drive by moving the holder up and down, the holder needs to be rotated just slightly to load and unload the disk cartridge 51. As a result, the disk drive can have a reduced size.

Optionally, a holding notch 25 may be cut through both the lower surface 2c and the first side surface 2a of the case body 10 and another holding notch 25 may be cut through both the lower surface 2c and the second side surface 2b thereof. These holding notches 25 may be used in a disk drive with a consecutive loading type rack, which can house a number of disk cartridges therein, to get engaged with a changer for automatically moving one of those disk cartridges after another from the rack to a recordable/playable position, or vice versa. Furthermore, a notch or a recess 30 may be cut through the second side surface 2b.

On the first side surface 2a, the side window 22 of the head window 12 is positioned closer to the lower surface 2c. In order not to interfere with the side window 22, the shutter opening groove 24 and the holding recess 26 are located over the side window 22 (i.e., closer to the upper surface 1a) with the sidewall defining the shutter opening groove 24 interposed between them.

The first side surface 2a also has an elastic member sliding groove 31, which extends parallel to, and is continuous with, the shutter opening groove 24. As will be described in detail later, one end of the elastic member 7 slides in the elastic member sliding groove 31, thereby applying elastic force to a portion of the shutter 11. There are recesses 27 and 28 at both ends of the elastic member sliding groove 31. Specifically, the recess 28 is used to fix one end of the elastic member 7 thereon. When engaged with the other end of the elastic member 7, the other recess 27 prevents the elastic member 7 from stretching, thereby keeping the shutter 11 locked and fixed as will be described in detail later. When the other end of the elastic member 7 is not engaged with the recess 27 but rests on the bottom of the elastic member sliding groove 31, the other end of the elastic member 7 moves in the elastic member sliding groove 31.

The shutter 11 includes a shield 5 and an unlocking member 8. Specifically, the shield 5 includes a bottom portion 5b that covers the bottom window 21 of the head window 12, a side portion 5a that covers the side window 22 thereof, and an engaging portion 5e arranged at the end of the side portion 5a so as to be inserted into the shutter opening groove 24. At both ends of the engaging portion 5e, there are U-shaped holding portions 5d with a rectangular bottom for holding the unlocking member 8. The shield 5 further includes a contacting portion 5c that has a rectangular notch and that is inserted into the shutter opening groove 24.

The unlocking member 8 unlocks the shutter 11 that is closed with the elastic member 7. For that purpose, the unlocking member 8 has an operating portion 81 to contact with the shutter opener 90 of the disk drive and a contacting portion 82a with a sloped notch at both ends thereof. The unlocking member 8 is inserted into the holding portions 5d at both ends of the engaging portion 5e of the shield 5. And the unlocking member 8 and the engaging portion 5e are inserted into the shutter opening groove 24. The length L1 of the engaging portion 5e is shorter than the distance L2 between the operating portion 81 and the contacting portion 82a of the unlocking member 8. The bottom portion 5b of the shield 5 has one end pressed by a stopper 6 against the lower surface 2c of the case body so as not to create a gap between the lower surface 2c and itself.

Being guided by the unlocking member 8 and engaging portion 5e that have been inserted into the shutter opening groove 24 and by the stopper 6, the shutter 11 slides parallel to the inserting direction A. In this manner, the shutter 11 can take a position where it has closed the head window 12 and a position where it has opened the head window 12.

The elastic member 7 contacts with the contacting portion 82a of the shutter 11, thereby applying elastic force to the shutter 11 in the inserting direction A such that the shutter 11 closes the head window 12. In this preferred embodiment, the elastic member 7 is a torsion spring. Alternatively, a spring of any other shape or a resin molded elastic member may also be used. The elastic member 7 has ends 71 and 72 and is deformed elastically. Even so, the elastic member 7 will soon restitute so as to maintain a predetermined distance between the ends 71 and 72. The end 72 is inserted into the recess 28 of the elastic member sliding groove 31. On the other hand, as long as the shutter 11 closes the head window 12, the end 71 is engaged with the recess 27, thus preventing the elastic member 7 from moving in the inserting direction A or in the opposite direction. While the shutter 11 is going to open, the end 71 slides on the bottom of the elastic member sliding groove 31. As shown in FIG. 2, while the shutter 11 is closed, the operating portion 81 of the unlocking member 8 is located closer to the fourth side surface 2e than the holding recess 26 is inside the shutter opening groove 24. In other words, the holding recess 26 is located closer to the third side surface 2d than the operating portion 81 of the unlocking member 8 is.

Hereinafter, it will be described how the shutter 11 operates. As shown in FIG. 2, when the disk cartridge 51 is inserted into the disk drive in the inserting direction A, the shutter opener 90 is inserted through the opening of the third side surface 2d into the shutter opening groove 24. The shutter opener 90 is fixed in the disk drive. Therefore, as the disk cartridge 51 is inserted deeper, the shutter opener 90 relatively moves in the direction D, which is opposite to the inserting direction A, inside the shutter opening groove 24. Then, the shutter opener 90 soon contacts with the operating portion 81 of the unlocking member 8 and presses the unlocking member 8 in the direction D. As described above, since the distance L2 between the operating portion 81 and the contacting portion 82a of the unlocking member 8 is greater than the length L1 of the engaging portion 5e of the shield 5, only the unlocking member 8, without the shield 5, advances in the direction D at first. As a result, the end 71 of the elastic member 7 is inserted into the notch of the contacting portion 82a.

As the unlocking member B goes farther in the direction D due to the relative movement of the shutter opener 90, the end 71 of the elastic member 7 soon makes a contact with the sloped portion of the notch. As a result, the end 71 is lifted from the recess 27 and moved onto the bottom of the elastic member sliding groove 31. In this manner, the shutter is unlocked. As the unlocking member 8 goes even deeper in the direction D, the contacting portion 81 soon makes a contact with the holding portion 5d of the engaging portion 5e of the shield 5. And due to the relative movement of the shutter opener 90, the unlocking member 8 and the shield 5 are moved together in the direction D. In the meantime, the end 71 of the elastic member 8 moves on the bottom of the elastic member sliding groove 31. That is to say, the shutter portion 11 begins opening the head window 12.

Thereafter, as the disk cartridge 51 is inserted even deeper, the shutter opener 90 further moves relatively in the shutter opening groove 24 and the shield 5 goes farther in the direction D. Consequently, the head window 12 is fully opened and the information storage medium 3 is exposed through the head window 12.

When the disk cartridge 51 is fully inserted into the disk drive, the information storage medium 3 is mounted on the turntable of the disk drive. At this point in time, the shutter opener 90 is located at a predetermined position in the shutter opening groove 24 and the elastic member 8 prevents the shutter 11 from moving in the direction in which the shutter 11 closes the head window 12. For that reason, as long as the disk drive is loaded with the disk cartridge 51, the shutter 11 keeps the head window 12 open.

To unload the disk cartridge 51 from the disk drive by pressing an eject button, for example, an unloading mechanism (not shown) unloads the disk cartridge 51 in the opposite direction to the inserting direction A. Specifically, the shutter opener 90 relatively moves in the inserting direction A within the shutter opening groove 24, and therefore, the end 71 of the elastic member 7 applies elastic force to the contacting portion 82a, and eventually the shutter 11, in the inserting direction A. That is to say, the elastic member 7 applies the elastic force to the shutter 11 so as to close the head window 12. When the shutter 11 reaches a position where the shutter 11 closes the head window 12 fully, the end 71 of the elastic member 7 is inserted into the recess 27 of the elastic member sliding groove 31. As a result, the shutter 11 closes the head window 12 fully. Also, the shutter 11 is locked so as not to move and open the head window 12.

If the user attempts to move only the shield 5 of the shutter 11 in the direction D manually, for example, then only the shield 5 will move in the direction D and the contacting portion 5c at one end of the engaging portion 5e of the shield 5 will contact with the end 71 of the elastic member 7. This is because the distance L2 between the operating portion 81 and the contacting portion 82a of the unlocking member 8 is greater than the length L1 of the engaging portion 5e of the shield 5. However, as the notch of the contacting portion 5c is rectangular, the end 71 cannot be lifted from the recess 27 and cannot move in the direction D along with the shield 5. That is to say, the shutter 11 is kept locked by the end 71 of the elastic member and will not be unlocked easily. Besides, since the operating portion 81 of the unlocking member 8 is located inside the shutter opening groove 24, it is also difficult for the user to open the shutter 11 by pressing the operating portion 81 with a finger, for example.

According to this preferred embodiment, the elastic member 7 applies elastic force to the shutter 11 such that the shutter 11 closes the head window 12. Thus, by keeping the head window 12 closed except when the head window 12 should be opened, the dustproofness can be increased. For example, even if the disk cartridge 51 were dropped by mistake, it would be also possible to prevent the head window 12 from being opened accidentally due to the impact caused by the drop. In addition, by designing the unlocking member 8 such that the shutter is opened only when the contacting portion 81 of the unlocking member 8 is operated, it is also possible to prevent the user from opening the head window by operating the shutter either by mistake or on purpose.

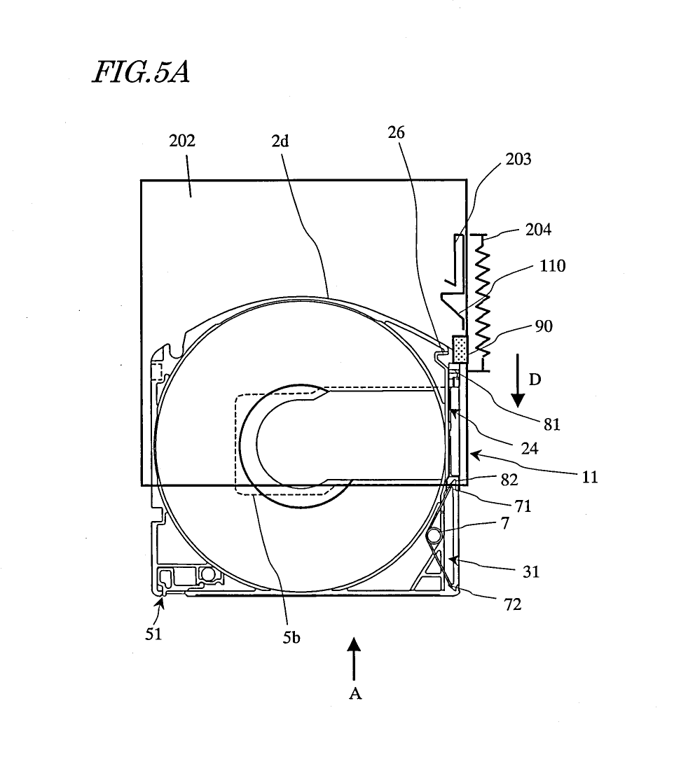

Next, it will be described in detail how to load the disk cartridge 51 into a disk drive. FIG. 4 illustrates an exemplary disk drive compatible with the disk cartridge 51. This disk drive includes a chassis 201, a cartridge holder 202, and a spindle motor 205.

The spindle motor 205 with a turntable is supported on the chassis 201. Although not shown in FIG. 4, a disk drive usually includes a record/reproduce head that is supported on the chassis 201. On the chassis 201, also arranged are positioning pins 201a for positioning the disk cartridge 51 such that the information storage medium 3 in the disk cartridge 51 will be mounted on the turntable 5 of the spindle motor 205 appropriately. The chassis 201 is secured to the housing of the disk drive via a damper 208, for example.

The holder 202 defines an insertion port 202b for inserting the disk cartridge 51 and a disk cartridge holding space 202c. A slider 203 is arranged on a side surface of the holder 202 and a spring 204 applies elastic force to the slider 203 in the opposite direction to the direction pointed by the arrow A (i.e., in the direction in which the disk cartridge 51 is ejected from the insertion port 2b). The slider 203 includes a contacting portion that contacts with the third side surface 2d of the disk cartridge 51 that has been inserted into the holder 2. Also, a gripping member 110 to get engaged with the holding recess 26 of the disk cartridge 51 is connected.

If the disk cartridge 51 is inserted through the insertion port 202b into the space 202c of the holder 202 in the direction pointed by the arrow A, the disk cartridge 51 soon contacts with the slider 203. By pushing the disk cartridge 51 even deeper against the elastic force applied by the spring 204, the disk cartridge 51 is further inserted and gets held on the holder 202. At this point in time, the gripping member 110 gets engaged with the disk cartridge 51 as will be described later. When the disk cartridge is inserted fully, the slider 203 is locked to the holder 202 by a locking mechanism (not shown). As the disk cartridge is inserted deeper, the shutter of the disk cartridge is opened gradually.

The holder 202 is secured to the chassis 201 so as to turn around the axis 202a of rotation. FIG. 4 illustrates a position of the holder 202 where the disk cartridge 51 is readily insertable into, and removable from, the holder 202 through the insertion port 202b. This position will be referred to herein as a “first position”.

If the holder 202 including the disk cartridge 51 inserted is brought closer to the chassis 201, the holder 202 soon reaches a position where the information storage medium 3 in the disk cartridge is mounted on the turntable of the spindle motor 5. This position will be referred to herein as a “second position”. At the second position, the information storage medium 3 starts rotating under the driving force of the spindle motor 5 and data can be reproduced from, or recorded on, the disk by using the head.

If the holder 202 is turned to go back from the second position to the first position, the slider 203 is unlocked and goes back to its rest position due to the elastic force applied by the spring 204. As a result, the disk cartridge is ejected by a predetermined distance as measured from the insertion port 2b and gets ready to be removed.

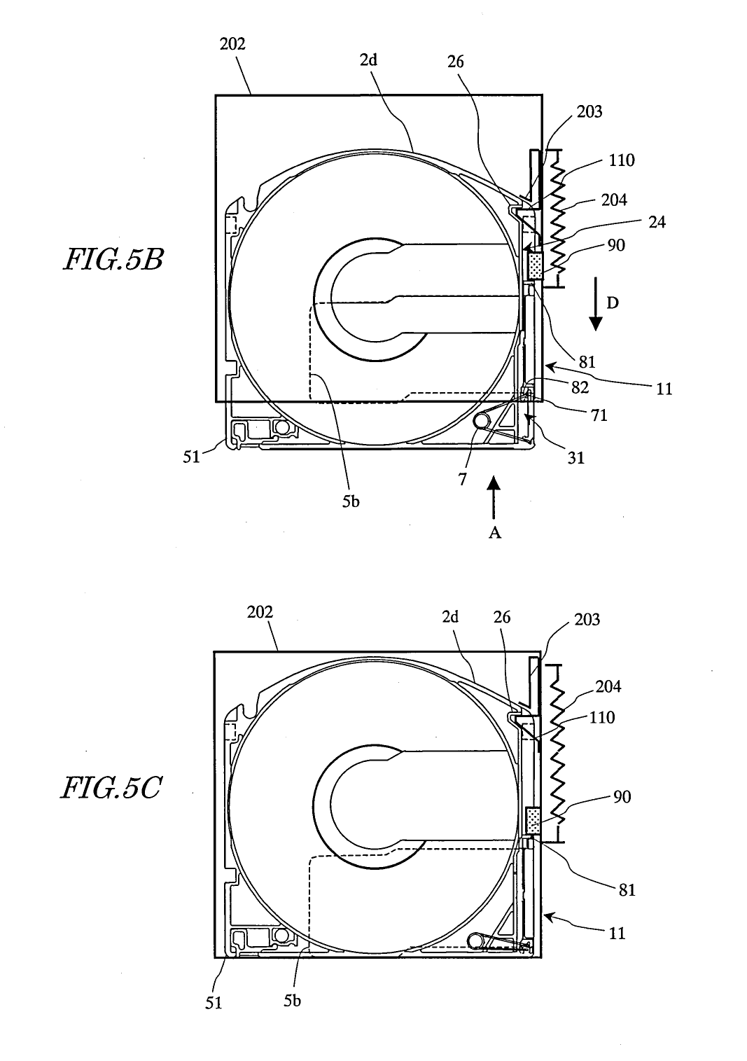

Hereinafter, the operations of inserting and ejecting the disk cartridge 51 into/from the holder 202 will be described in further detail with reference to FIGS. 5A through 5D, which schematically illustrate the gripping member 110, the slider 203, the spring 204 and the shutter opener 90. As described above, the gripping member 110 and the slider 203 are supported so as to be movable with respect to the holder 202 and are subjected to the elastic force applied by the spring 204 in the direction opposite to that pointed by the arrow A. On the other hand, the shutter opener 90 is fixed on the holder 202.

As shown in FIG. 5A, as the disk cartridge 51 is going to be inserted deeper into the holder 202 as pointed by the arrow A, the shutter opener 90 soon contacts with the operating portion 81 of the unlocking member 8 of the shutter 11. If the disk cartridge 51 is inserted even deeper, then the unlocking member 8 that has contacted with the shutter opener 90 as described above unlocks the shutter that has been locked by the spring 7.

Next, as the disk cartridge 51 is inserted even deeper into the holder 202 as pointed by the arrow A, the unlocking member 8 and the shield 5 that have contacted with the shutter opener 90 remain at the same position but the body 10 of the disk cartridge 51 is inserted deeper into the holder 202. As a result, the shutter 11 moves relatively in the direction opposite to that pointed by the arrow A as shown in FIG. 5B. Then, the holding recess 26 of the cartridge body 10 gets engaged with the gripping member 110. At this point in time, the slider 203 also contacts with the third side surface 2d of the cartridge body 110. That is why to insert the disk cartridge 51 even deeper into the holder 202 as pointed by the arrow A, the disk cartridge 51 needs to be pushed against the elastic force applied by the spring 204 that is connected to the slider 203.

Subsequently, when the disk cartridge 51 is inserted fully into the holder 202, the slider 203 will be locked to the holder 202 as shown in FIG. 5C. As the disk cartridge 51 is going to be inserted, the shutter 11 of the disk cartridge 51 is opened gradually. In this state, the holder 202 is turned toward the chassis 201 to take the second position, where the information storage medium 3 in the disk cartridge 51 is mounted on the turntable.

If the holder 202 is turned to go back from the second position to the first position again, the slider 203 is unlocked. Then, the slider 203 moves in the direction pointed by the arrow D under the elastic force applied by the spring 204. As a result, the disk cartridge 501 is pushed out of the holder 202. At this point in time, the elastic member 7 of the disk cartridge 51 pushes the unlocking member 8 of the shutter 11. Thus, the shutter 11 does not move along with the cartridge body 10 of the disk cartridge 51 in the direction pointed by the arrow D but the unlocking member 8 keeps contact with the shutter opener 90. That is to say, the unlocking member 8 moves relatively to the cartridge body 10 so as to close the shutter 11. When the spring 204 connected to the slider 203 returns to its rest position, the slider 203 will stop moving. At that point in time, the front end of the disk cartridge 51 will be closer to the user by a distance S than that of the holder 202 is. In this manner, the unloading operation is finished. As described above, during the operations of loading and unloading the disk cartridge 51, the gripping member 110 also moves as the slider 203 moves.

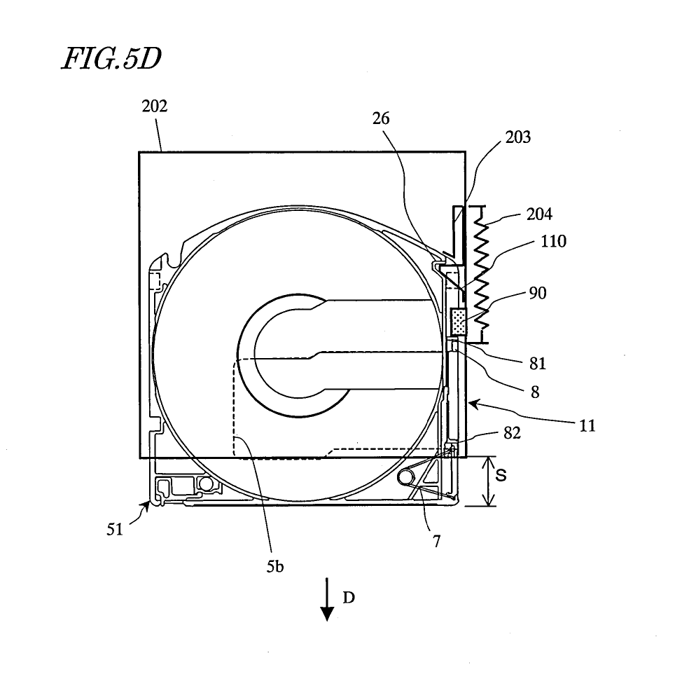

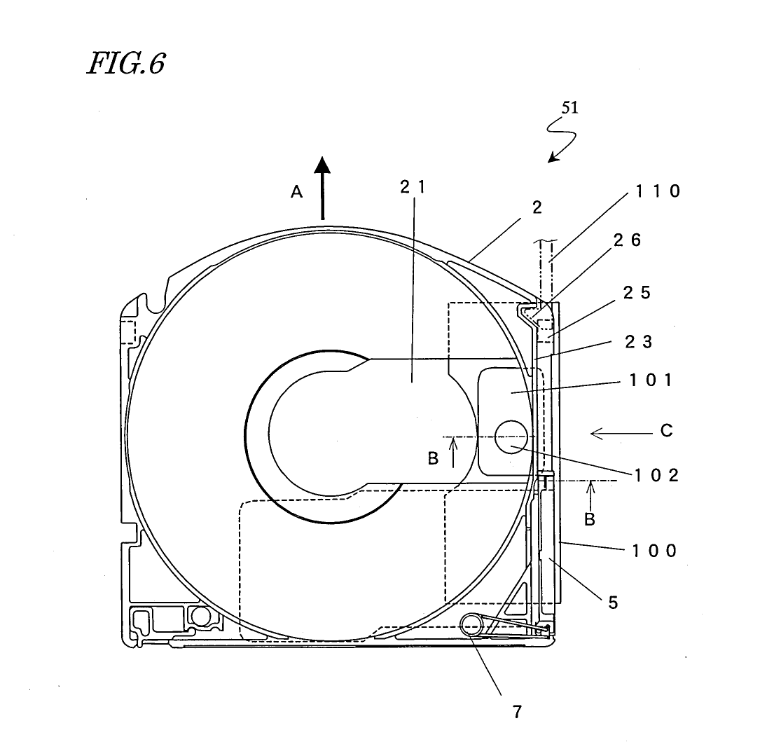

Next, the position of the disk cartridge 51 in the disk drive will be described in detail. FIG. 6 is a plan view illustrating the position of the lower half of the disk cartridge 51 in the disk drive and FIG. 7 shows a cross section of the overall disk cartridge 51 as viewed on the plane B-B shown in FIG. 6. In FIGS. 6 and 7, the disk cartridge 51 has been loaded into the disk drive and the shield 5 has been opened fully. The head 100 is now located under the outermost zone of the information storage medium 3. And a lens actuator 101 for getting focusing and tracking operations done by driving an objective lens 102 has been inserted into the head window 12. The head window 12 has the side window 22. That is why even the lens actuator 101 with big outer dimensions never gets stuck on the side window 22 or contacts or interferes with the case body 10. Therefore, there are no size regulations on the lens actuator, and the disk cartridge 51 of the present invention can be loaded into even a disk drive with a big lens actuator.

Besides, as there is no longer any need to provide an access space for the lens actuator between the side surface of the disk cartridge 51 and the information storage medium, the case body 10 of the disk cartridge 51 can have a reduced width as measured perpendicularly to the inserting direction A.

As can be seen, to avoid any contact or interference between the head 100 and the disk cartridge 51 in a situation where the disk cartridge 51 has been loaded into the disk drive, the side window 22 of the head window 12 preferably reaches the level H1 that is as high as the information storage side 3a of the information storage medium as measured from the lower surface 2a when the information storage medium 3 is held so as to get information reproduced from or recorded on.

As described above, to load the disk cartridge 51 into the drive, first, the disk cartridge 51 is inserted into the holder 202 that has been raised to the first position, and then gets held by engaging the gripping member 110 with the holding recess 26 in the shutter opening groove 24. After that, by turning the holder 202, the overall disk cartridge 51 is brought down with the gripping member 110 and fixed at a predetermined position using the positioning pins.

At that time, since the shutter 11 is opened as described above, the information storage medium is mounted on the turntable and the lens actuator of the record/reproduce head is inserted into the head window. The disk cartridge 51 in the descended state is positioned by the gripping member 110 and needs to be held properly so as to avoid contact with the turntable or the record/reproduce head. Since some gap is usually created between the upper and lower halves 1 and 2 that have been bonded together, the disk cartridge 51 can be held more appropriately by making the holding recess 26 form an integral part of the lower half 2 as is done in this preferred embodiment.

Meanwhile, to unload the disk cartridge 51 in such a state, the disk cartridge 51 is raised by turning the holder 202. As a result, the slider 203 is unlocked to eject the disk cartridge 51 partially. At this point in time, to prevent the disk cartridge 51 from being popped out of the disk drive due to the reactive force of the elastic member 7, the gripping member 110 moves the disk cartridge 51 to the eject position while keeping engaged with the holding recess 26.

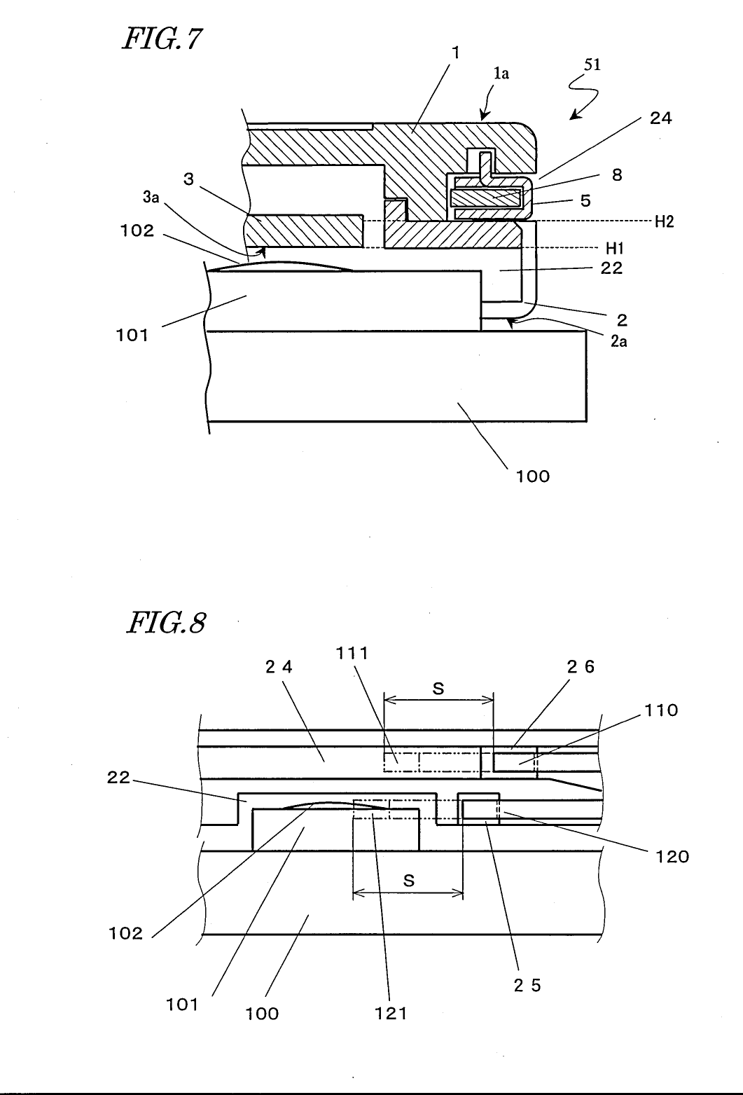

FIG. 8 shows a side view of the overall disk cartridge 51 as viewed from the direction C shown in FIG. 6. As shown in FIG. 8, the gripping member 110 that has held the disk cartridge 51 thereon by engaging with the holding recess 26 raises the disk cartridge 51 once and moves to a standby position 111, which is closer to the insertion port by the distance S, while the disk cartridge 51 is being ejected. Even after the disk cartridge 51 has been removed, the gripping member 110 stands by at that position. When the disk cartridge 51 is inserted next time, the gripping member 110 holds the disk cartridge again and returns to the position indicated by the solid lines.

In the vacant state in which no disk cartridge 51 has been inserted into the holder 202, the holder 202 is brought down with the gripping member 110 still staying at the standby position 111. However, the holding recess 26 is located at a higher level than the side window 22. That is why even if the standby position 111 is above the side opening 22 of the head window 12, the gripping member 110 never interferes with the lens actuator 101 of the head 100.

Suppose such an operation of the gripping member 110 were performed by a gripping member 120 to get engaged with a holding recess 25, not the holding recess 26. In that case, since the holding recess 25 would be located at the same level as the side window 22, the standby position 121 of the gripping member 120 would enter the side window 22. That is why when the record/reproduce head 100 is located around the outermost zone, the gripping member 121 might interfere with the lens actuator 101 in the vacant state in which no disk cartridge 51 has been inserted. According to the present invention, such an unwanted situation can be avoided.

To prevent the gripping member 110 from interfering with the head 100, when the information storage medium 3 is held in the disk drive to have information reproduced from and/or recorded on it, the holding recess 26 is preferably located closer to the upper surface 1a than the level H1 of the information storage side 3a of the information storage medium 3 is. For that purpose, the shutter opening groove 24 is also preferably located closer to the upper surface 1a than the level H1 of the information storage side 3a of the information storage medium 3 is as shown in FIG. 7. Particularly, by arranging the holding recess 26 over the intermediate level H2 between the upper and lower surfaces 1a and 2a of the case body (i.e., in the upper portion of the space between the upper and lower surfaces 1a and 2a), even when the vacant holder 202 is brought down, it is also possible to prevent the gripping member 110, engaged with the holding recess 26, from interfering with the head 100.

As described above, according to this preferred embodiment, the gripping member that prevents the disk cartridge from being popped out due to the reactive force applied by the elastic member gets engaged with the holding recess in the shutter opening groove. Accordingly, even if the gripping member is lifted to a certain degree from the holding recess, the gripping member will still be located within the shutter opening groove and its position will be regulated by the shutter opening groove. That is why the gripping member does not disengage itself from the holding recess easily and can prevent the unwanted movement of the disk cartridge without fail. Besides, no extra holding recesses have to be provided in addition to that located within the shutter opening groove, and the holding recess on a side surface of a small-sized disk cartridge can work efficiently. Furthermore, the head window is located closer to the lower surface than the shutter opening groove is, and is not continuous with the shutter opening groove. Consequently, the gripping member never enters the head window while the disk cartridge is being inserted or ejected.

In the preferred embodiment described above, the head window 12 is cut through only the back surface of the case body. Optionally, the upper surface of the case body may also have a head window.

In the preferred embodiment described above, a structure in which the elastic member locks the shutter is adopted. Optionally, another locking mechanism, as well as the elastic member, may be provided for the disk cartridge. Or the disk cartridge may have no locking mechanisms at all.

### INDUSTRIAL APPLICABILITY

According to the present invention, a small-sized and highly dustproof disk cartridge is provided. This disk cartridge is applicable to any of various disklike information storage media on which a write operation can be performed optically, magneto-optically or magnetically. The present invention can be used particularly effectively in a small-sized information storage medium with high storage capacity.

1. A disk cartridge comprising
a case body for housing a disklike information storage medium in a rotatable position, the case body including: first and second side surfaces that extend parallel to an inserting direction, in which the disk cartridge is inserted into a disk drive for recording and/or reproducing information, and are opposed to each other; a lower surface sandwiched between the first and second side surfaces; a head window, cut through a portion of the lower surface, for partially exposing the information storage medium; a shutter opening groove provided on the first side surface so as to extend in the inserting direction and to slide a shutter opener of the disk drive therein; and a holding recess, which is positioned at the bottom of the shutter opening groove so as to get engaged with a gripping member of the disk drive while the disk cartridge is loaded in the disk drive;
a shutter, which has an operating portion that protrudes into the shutter opening groove and which opens or closes the head window by sliding parallel to the inserting direction; and
an elastic member for applying elastic force to the shutter so as to close the head window.

2. The disk cartridge of claim 1, wherein the head window has been cut open through the first side surface and the lower surface so as to reach the first side surface.

3. The disk cartridge of claim 2, wherein the head window has been cut open through the first side surface so as not to interfere with the shutter opening groove or the holding recess.

4. The disk cartridge of claim 3, wherein the head window includes a side window that has been cut open through the first side surface and that is located closer to the lower surface than the shutter opening groove is.

5. The disk cartridge of claim 1, wherein the case body includes an upper half and a lower half, and
wherein the holding recess is defined by a rib of the lower half so as to form an integral part of the lower half.

6. The disk cartridge of claim 1, wherein the case body has a holding notch that has been cut through the first side surface and the lower surface and another holding notch that has been cut through the second side surface and the lower surface.

7. The disk cartridge of claim 1, wherein the case body includes an elastic member sliding groove, which extends parallel to the shutter opening groove to have the elastic member slide therein, and a recess located at one end of the elastic member sliding groove, the elastic member sliding groove and the recess being both provided on the first side surface, and
wherein while the head window is closed with the shutter portion, the elastic member engages with the recess, thereby keeping the shutter portion locked and fixed.

8. The disk cartridge of claim 7, wherein the shutter includes a shield, which covers the head window, and an unlocking member including the operating portion, and
wherein when the shutter opener contacts with the operating portion, the unlocking member disengages the elastic member from the recess and the shutter opener slides the shutter portion against the elastic force applied by the elastic member.

9. The disk cartridge of claim 1, wherein the case body includes a third side surface, which faces the disk drive when the disk cartridge is going to be inserted into the disk drive, and a fourth side surface opposed to the third side surface, and
wherein the shutter opening groove reaches the third side surface so as to form an opening on the third side surface.

10. The disk cartridge of claim 1, further comprising the disklike information storage medium with an information storage side, wherein the information storage medium is housed in the case body such that the information storage side is partially seen through the head window when the shutter is opened.

11. The disk cartridge of claim 10, wherein the case body further includes an upper surface that is sandwiched between the first and second side surfaces and that is opposed to the lower surface, and
wherein the holding recess is positioned at the bottom of the shutter opening groove so as to be located closer to the upper surface than the information storage side of the information storage medium is when the information storage medium has been loaded into the disk drive such that information is readily reproduced from, or recorded on, the medium.

12. The disk cartridge of claim 10, wherein the holding recess is positioned at the bottom of the shutter opening groove so as to be located in the upper part of a space between the upper and lower surfaces of the case body.

13. A disk drive comprising:
a chassis;
a motor supported on the chassis and including a turntable;
a head, supported on the chassis, for recording and/or reproducing information;
a holder having an insertion port for inserting the disk cartridge of claim 1 and a space for holding the disk cartridge, the holder being rotatably secured to the chassis so as to take either a first position, at which the disk cartridge is insertable and removable through the insertion port without interfering with the turntable, or a second position, at which the information storage medium in the disk cartridge held in the space is mounted on the turntable;
a slider, which is arranged so as to slide with respect to the holder and which applies elastic force to the disk so as to eject the disk cartridge out of the holder through the insertion port; and
a gripping member, which is connected to the slider so as to get engaged with the holding recess of the disk cartridge,
wherein the gripping member is arranged on the holder so as not to interfere with the head when the holder is turned to take the second position with no disk cartridge held.
